(19) United States
(12) Patent Application Publication
(10) Pub. No.: US 2025/0204690 A1
(43) Pub. Date: Jun. 26, 2025

(54) BED

(71) Applicant: COWAY Co., Ltd., Gongju-si (KR)

(72) Inventors: Chul Woo PARK, Seoul (KR); Hyun Hee LEE, Seoul (KR); Eu Jean MOON, Seoul (KR); In Seok SEO, Seoul (KR); Young Ju SEO, Seoul (KR); Min Chul YONG, Seoul (KR); Il Song PARK, Seoul (KR); Kwang Hwan PARK, Seoul (KR)

(73) Assignee: COWAY Co., Ltd., Gongju-si (KR)

(21) Appl. No.: 18/987,897

(22) Filed: Dec. 19, 2024

(30) Foreign Application Priority Data
Dec. 20, 2023 (KR) 10-2023-0187672

(51) Int. Cl. A47C 19/02

(52) U.S. Cl. CPC A47C 19/025

(57) ABSTRACT

A bed includes: a mattress including a topper for supporting a user's body, and a body disposed below the topper to support the topper; a frame supporting the mattress; one or more air receiving parts supported by the body and configured to expand by receiving air or contract by discharging air to raise or lower the topper in an up-down direction to stretch the user's body; a pump configured to operates to inflate or deflate the one or more air receiving parts; a lifting part which is supported by the frame and moves up and down to raise and lower the mattress in the up-down direction to stretch the user's body; and a controller for controlling the operation of at least one of the pump and the lifting part unit to adjust an upward movement distance of the topper.

### TECHNICAL FIELD

The present disclosure relates to a bed.

### BACKGROUND

A bed functions to support the weight of a user lying down thereon. In addition, the bed can stretch the body of the user lying down for the health of the user. Such a bed may include a mattress composed of multiple layers for supporting the user and devices for raising or lowering the mattress to stretch the body of the user.

However, conventional beds have limited structures, making it difficult to adjust the stretching intensity provided to a user or to provide sufficient stretching intensity to the user.

In this regard, Korean Patent No. 10-1679584 of the applicant, Sungwoo Meditech Co., Ltd., entitled “Stretching bed equipped with airbag and massage rod” (Patent Document 1) discloses a bed including a cover that covers a mattress body, an airbag that is supported by the mattress and inflated to press against an upper surface of the cover to stretch a user, and a massage rod that moves along the upper surface of the cover to massage the user.

However, in the bed of Patent Document 1, the airbag is configured to inflate to a predetermined height, and the massage rod moves along a preset movement path, so that the upward movement distance of the upper surface of the cover caused by the airbag and the massage rod cannot be adjusted. In other words, the bed of Patent Document 1 cannot adjust the intensity of stretching applied to the user's body supported by the cover.

In addition, in the bed of Patent Document 1, the lifting distance of the cover moved upward by the movement of the massage rod is set to be smaller than the lifting distance of the cover moved upward by the inflation of the airbag, so that the cover cannot be raised higher than the height at which the airbag is inflated. In other words, in the bed of Patent Document 1, there is a problem that the stretching intensity cannot exceed the intensity of stretching caused by the airbag.

### PRIOR ART DOCUMENT

(Patent Document) Korean Patent No. 10-1679584

### SUMMARY

In view of the above, the present disclosure provides a bed capable of adjusting a movement distance of a topper in an up-down direction.

In accordance with an aspect of the present disclosure, there is provided a bed comprising: a mattress including a topper for supporting a user's body, and a body disposed below the topper to support the topper; a frame supporting the mattress; one or more air receiving parts supported by the body and configured to expand by receiving air or contract by discharging air to raise or lower the topper in an up-down direction to stretch the user's body; a pump configured to operates to inflate or deflate the one or more air receiving; a lifting part which is supported by the frame and moves up and down to raise and lower the mattress in the up-down direction to stretch the user's body; and a controller for controlling the operation of at least one of the pump and the lifting unit to adjust an upward movement distance of the topper.

Further, in the bed, wherein the one or more air receiving parts are arranged to overlap with a region extending directly upward from the lifting part so that the one or more air receiving parts are moved upward together with the mattress when the lifting part moves upward.

Further, in the bed, wherein the lifting part includes: a lifting member supported by the frame to be movable up and down and configured to move the mattress up and down; and a driving member for providing driving force to the lifting member.

Further, in the bed, wherein the controller controls the operation of the pump so that the one or more air receiving parts are expanded to raise the topper by a first movement distance, and controls the operation of the pump and the lifting unit so that the one or more air receiving parts are expanded and the lifting unit is moved upward to raise the topper by a second movement distance greater than the first movement distance.

Further, in the bed, wherein the controller controls the operation of the pump and the lifting unit so that the topper is raised by one of the one or more air receiving parts and the lifting unit, and then the topper is further raised by the other one of the one or more air receiving parts and the lifting unit.

Further, the bed further comprising an air flow path for allowing the pump and the one or more air receiving parts to communicate with each other; and a valve configured to be opened and closed to allow or restrict flow of air in the air flow path; wherein the one or more air receiving parts include: a lower cell; and an upper cell disposed on top of the lower cell, and wherein the controller controls the operation of the pump and the valve so that the lower cell and the upper cell are sequentially expanded.

Further, in the bed, wherein the upper cell and the lower cell are formed such that the height of the expanded upper cell and the height of the expanded lower cell are the same.

Further, wherein a lifting distance of the lifting unit is smaller than a height of the one or more air receiving parts expanded.

Further, wherein the lower cell includes a plurality of lower cells, and the plurality of lower cells are arranged adjacent to each other in a width direction of the bed so that the user's body supported by the topper is positioned in a region extending directly upward between the plurality of lower cells.

Further, wherein the upper cell is formed in a bar-like shape extending in a width direction of the bed so that the user's body supported by the topper is positioned in a region extending directly upward from the upper cell.

Further, the bed comprising an air flow path connected to the pump and the one or more air receiving parts to provide a passage through which air flows, wherein the frame has a frame hole, the body has a body hole, the frame hole and the body hole communicate with each other, and the air flow path passes through the frame hole and the body hole and is connected to the one or more air receiving parts.

Further, wherein the lifting unit moves a lower surface of the body up and down in the up-down direction to raise or lower the topper.

Further, wherein the frame includes: a support frame supporting the lifting unit and the one or more air receiving parts; and one or more rotation frames arranged to be rotatable relative to the support frame.

According to one embodiment of the present disclosure, the bed can adjust the movement distance of the topper in the up-down direction, so that the stretching intensity can be adjusted step by step.

In addition, since the air receiving part and the lifting part are arranged to overlap each other in the up-down direction, by the combined action of the air receiving part and the lifting unit, the movement distance of the topper in the up-down direction can exceed the height of the expanded air receiving part or the lifting distance of the lifting part, so that the stretching intensity can be maximized.

Further, since the plurality of lower cells can be arranged in the width direction of the bed so that the user's body is positioned in a region extending directly upward between the plurality of lower cells, the plurality of lower cells can stably support the user's body while expanded.

Furthermore, since the upper cell and the lifting member are formed in a bar shape, the overlapping area with the user's body supported by the topper can be minimized, so that a strong stimulus can be provided to the user.

### BRIEF DESCRIPTION OF THE DRAWINGS

FIG. 1 is a perspective view of a bed according to one embodiment of the present disclosure.

FIG. 2 is a view showing the bed of FIG. 1 with a topper raised upward.

FIG. 3 is an exploded perspective view of the bed of FIG. 1.

FIG. 4 is an exploded perspective view of a mattress of FIG. 3.

FIG. 5 is a view showing a fixing part of a lifting unit supported by the mattress of FIG. 4.

FIG. 6 is a view showing an expanded state of an air receiving part of the lifting unit supported by the mattress of FIG. 4.

FIG. 7 is a bottom perspective view of the air receiving part of FIG. 6.

FIG. 8 is a cross-sectional view of the bed taken along line VIII-VIII in FIG. 1.

### DETAILED DESCRIPTION

Hereinafter, specific embodiments for implementing the technical ideas of the present disclosure will be described in detail with reference to the drawings.

In addition, in describing the present disclosure, when it is determined that a detailed description of the relevant known configuration or function may obscure the gist of the present disclosure, the detailed description will be omitted.

Further, when a component is described as being “connected” or “flowing” to another component, it should be understood that it may be directly connected or flowing to another component, but there may be other components in between.

The terms used in the present specification are used merely to describe the specific embodiments and are not intended to limit the present disclosure. Singular expressions include the plural unless the context clearly indicates otherwise.

In addition, it should be noted in advance that in the present specification, expressions such as upper, lower, side, etc. are described based on the illustrations in the drawings, and may be expressed differently if the orientation of the subject is changed. For the same reason, in the accompanying drawings, some components are exaggerated, omitted, or schematically shown, and the size of each component does not entirely reflect the actual size.

Furthermore, the terms containing ordinal numbers, such as first, second, etc., may be used to describe various components, but the components are not limited by such terms. These terms are used only to distinguish one component from another.

The meaning of “include” used in the present specification is intended to specify certain features, areas, integers, steps, operations, elements, and/or components, and is not intended to exclude the existence or the addition of other specific features, areas, integers, steps, operations, elements, components, and/or groups.

Hereinafter, a bed 1 according to one embodiment of the present disclosure will be described with reference to the drawings.

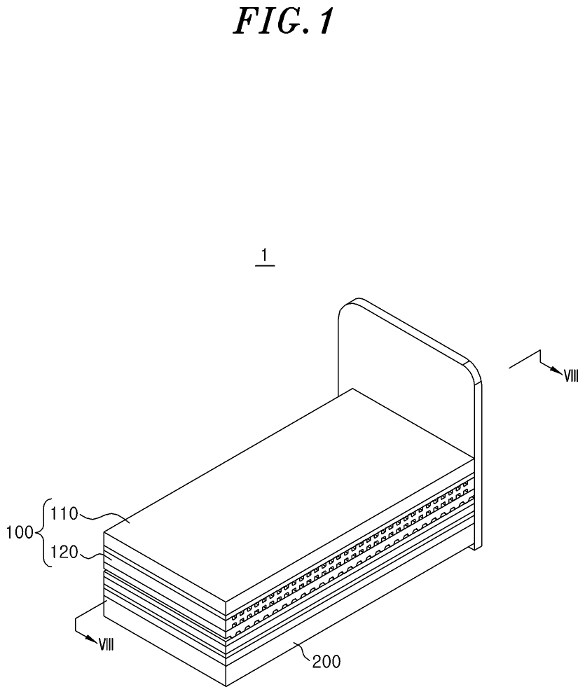

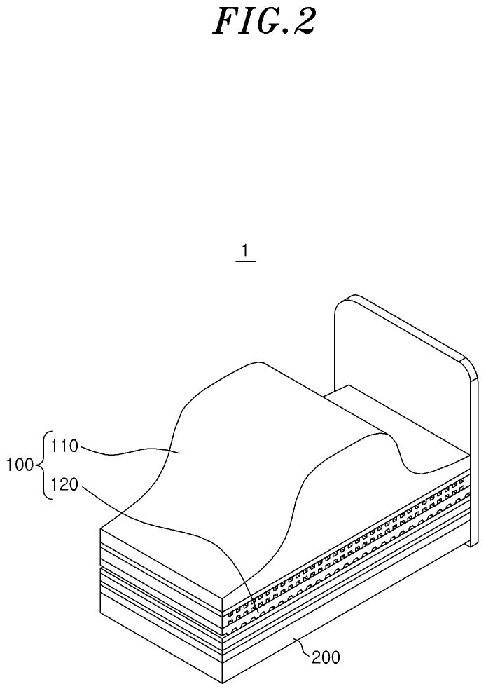

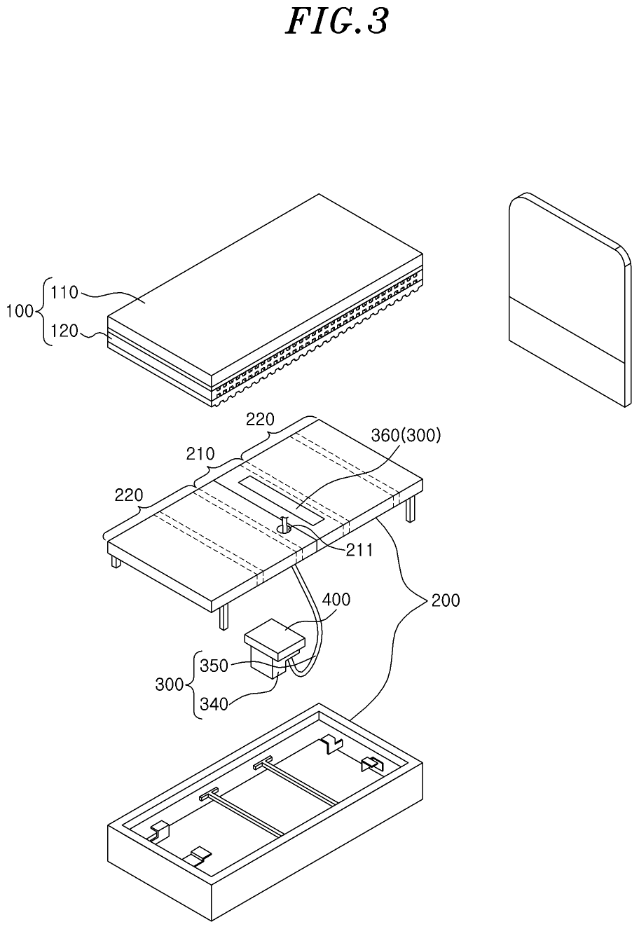

Referring to FIGS. 1 to 3, the bed 1 according to one embodiment of the present disclosure can support a user lying down or sitting. The bed 1 may be extended in one direction. When a user lies down on the bed 1, the user's head and legs may be aligned along the one direction. In addition, the one direction may be referred to as a front-back direction. The bed 1 may include a mattress 100, a frame 200, a lifting unit 300, and a controller 400.

The mattress 100 can support the user and provide cushioning to the user. In addition, the mattress 100 may be supported by the frame 200. The mattress 100 may include a topper 110 and a body 120.

The topper 110 may be disposed on top of the body 120 to support the user's body. In other words, the user can sit or lie on an upper surface of the topper 110. The topper 110 may be formed integrally with the body 120, but is not limited thereto, and may be provided separately from the body 120. For example, the topper 110 may be composed of a blanket, a pad, and the like that are not integrally formed with the body 120. In addition, the topper 110 may be provided in a plurality and stacked in an up-down direction. The topper 110 may have a predetermined thickness.

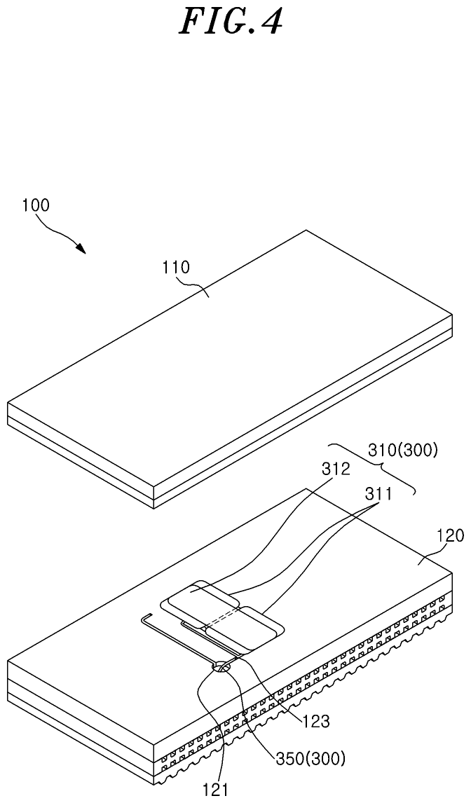

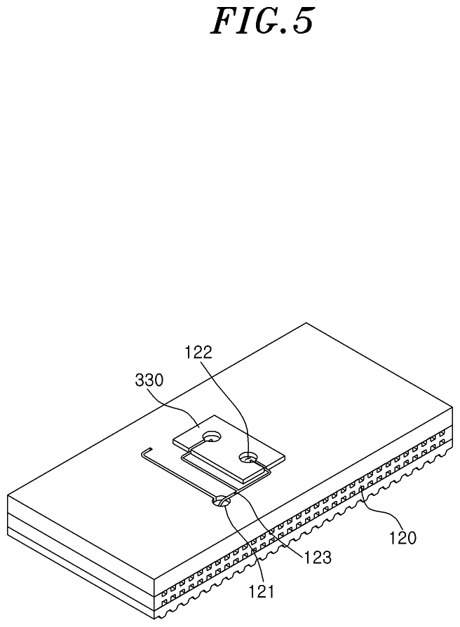

Referring further to FIGS. 4 and 5, the body 120 may be disposed below the topper 110 to support the topper 110. In addition, the body 120 may be disposed above the frame 200. The body 120 may have a predetermined thickness. The body 120 may provide cushioning to the user together with the topper 110. The body 120 may have a body hole 121, a nipple groove 122, and a flow path groove 123.

The body hole 121 may provide a space into which a portion of an air flow path 350 to be described later can be inserted. The body hole 121 may be extended in the up-down direction.

The nipple groove 122 may provide a space in which a nipple 320 to be described later can be accommodated. The nipple groove 122 may be formed by being recessed downward from an upper surface of the body 120.

The flow path groove 123 may provide a space into which another portion of the air flow path 350 can be inserted. The flow path groove 123 may be extended along the upper surface of the body 120 from the body hole 121 toward an air receiving part 310 to be described later. In addition, a plurality of flow path grooves 123 may be formed. Any one of the plurality of air flow grooves 123 may connect the body hole 121 and the nipple groove 122.

The frame 200 can support the mattress 100. The frame 200 may form the exterior of the bed 1. The frame 200 may include a support frame 210 and a rotation frame 220.

The support frame 210 may be disposed under the mattress 100 to support a lifting part 360 and an air receiving part 310 of the lifting unit 300, which will be described later. The support frame 210 may be configured not to rotate. In addition, the support frame 210 may have a frame hole 211 formed therein.

The air flow path 350 may pass through the frame hole 211. The frame hole 211 may be positioned directly below the body hole 121 to communicate with the body hole 121.

The rotation frame 220 may be arranged to be rotatable in the up-down direction with respect to the support frame 210 about a rotation center axis extending in a left-right direction. The rotation frame 220 may be disposed under the mattress 100. When the rotation frame 220 is rotated, at least a portion of the mattress 100 is rotated in the up-down direction together with the rotation frame 220, so that the orientation of the mattress 100 can be changed in the up-down direction. The rotation frame 220 and the support frame 210 may be arranged in a front-back direction. In addition, the rotation frame 220 may be provided as a plurality of rotation frames 220, and the support frame 210 may be disposed between the plurality of rotation frames 220, but the present disclosure is not limited thereto. Further, the rotation frame 220 may include a plurality of sub-rotation frames. Among the plurality of sub-rotation frames, one may be disposed to be rotatable with respect to the support frame 210, and another may be disposed to be rotatable with respect to one of the other the plurality of sub-rotation frames.

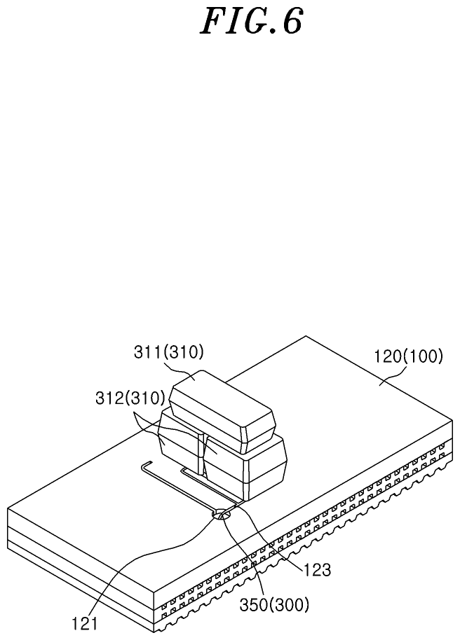

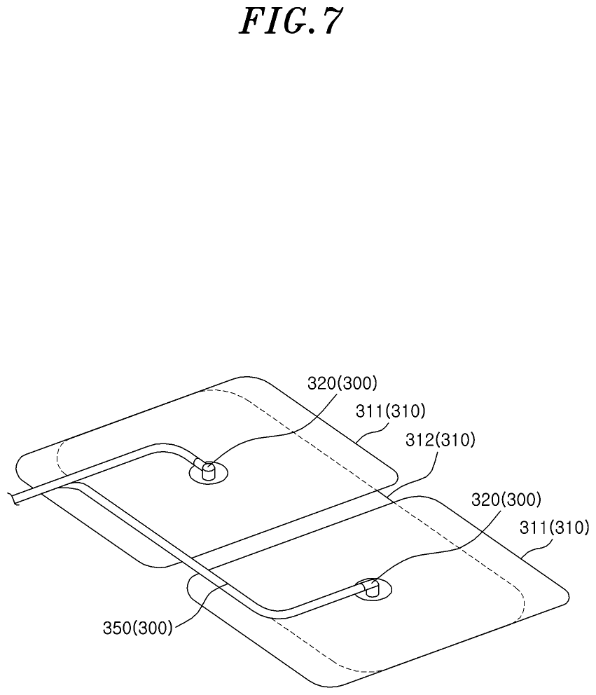

Referring further to FIGS. 5 to 7, the lifting unit 300 can raise or lower the mattress 100 in the up-down direction to stretch the user's body supported by the mattress 100. In other words, the lifting unit 300 can move a specific area of the mattress 100 up and down so that the user's back, waist, etc. are stretched. The lifting unit 300 may include an air receiving part 310, a nipple 320, a fixing part 330, a pump 340, an air channel 350, a lifting part 360, and a valve (not shown).

The air receiving part 310 can expand by receiving air or contract by discharging air to stretch the user's body. In other words, the air receiving part 310 can expand to accommodate a specified amount of air. The air receiving part 310 may be supported on the body 120. In addition, the air receiving part 310 may be disposed between the topper 110 and the body 120. The air receiving part 310 may be disposed to be positioned in a region directly above the support frame 210. The air receiving part 310 can raise a portion of the topper 110 when expanded, and can lower the raised portion of the topper 110 when contracted. The portion of the topper 110 that is raised due to the expansion of the air receiving part 310 may overlap with a region directly above the support frame 210. Further, the air receiving part 310 may be provided as a plurality of air receiving parts 310. At least some of the plurality of air receiving parts 310 may be formed differently from each other. In addition, at least some of the plurality of air receiving parts 310 may be stacked in the up-down direction. The plurality of air receiving parts 310 may include a lower cell 311 and an upper cell 312.

The lower cell 311 can support the left and right sides of the user's body. The lower cell 311 may be disposed on top of the body 120. In addition, the lower cell 311 may be provided as a plurality of lower cells 311. The plurality of lower cells 311 may be configured to expand or contract independently. The plurality of lower cells 311 may be arranged adjacent to each other in the left-right direction of the bed 1 so that the user's body is positioned in a region extending directly upward between the plurality of lower cells 311. The plurality of lower cells 311 can support the left and right sides of the user's body while being expanded. For example, when the user lies down on the mattress 100, the plurality of lower cells 311 can support the left and right sides of the user's waist so that the user's spine is positioned between the plurality of lower cells 311. In addition, some of the plurality of lower cells 311 may overlap each other in the up-down direction.

The upper cell 312 may be disposed on top of the lower cell 311. The upper cell 312 may be formed in a different shape than the lower cell 311. The upper cell 312 may be formed to have a longer length in the left-right direction than its length in the front-back direction. For example, the upper cell 312 may be in a bar-like shape. The user's body supported by the upper cell 312 may be positioned in a region extending directly upward from the upper cell 312. In addition, the length in the left-right direction of the upper cell 312 may be formed to be greater than the length in the left-right direction of the lower cell 311. In addition, the length in the left-right direction of the upper cell 312 may be smaller than the sum of the lengths in the left-right direction of the plurality of lower cells 311. The upper cell 312 may be disposed on upper surfaces of the plurality of lower cells 311. Further, the height of the expanded upper cell 312 may be smaller than the height of the expanded lower cell 311. However, the present disclosure is not limited to the above, and the upper cell 312 and the lower cell 312 may be formed such that the height of the expanded upper cell 312 and the height of the expanded lower cell 311 are the same. In addition, when viewed from above, the left end of the upper cell 312 may be positioned further to the left than the center of the leftmost lower cell 311 among the plurality of lower cells 311, and the right end of the upper cell 312 may be positioned further to the right than the center of the rightmost lower cell 311 among the plurality of lower cells 311.

The nipple 320 can direct air flowing in the air flow path 350 into the air receiving part 310 or direct air discharged from the air receiving part 310 into the air flow path 350. The nipple 320 may be connected to the air receiving part 310 and the air flow path 350. The nipple 320 may be connected to a lower surface of the air receiving part 310. For example, the nipple 320 may be fixed to the lower surface of the air receiving part 310 by ultrasonic welding. In addition, the nipple 320 may be received in the nipple groove 122.

The fixing part 330 can fix the air receiving part 310 to the body 120. The fixing part 330 may be disposed on the upper surface of the body 120. In addition, the fixing part 330 may have a sheet-like shape. For example, the fixing part 330 may be hot melt-bonded to the body 120 and connected to the air receiving part 310 by Velcro. When air is introduced into the lower cell 311, the lower cell 311 can expand while being supported by the body 120 through the fixing part 330. Further, a cutout may be formed in the fixing part 330 so that the nipple 320 and a portion of the air receiving part 310 can pass therethrough. The cutout may communicate with the nipple groove 122. The nipple 320 can pass through the cutout to be received in the nipple groove 122.

The pump 340 can operate to inflate or deflate the air receiving part 310. In other words, the pump 340 can supply air into one or more of the lower cell 311 and the upper cell 312 or draw air from them. The pump 340 may be disposed below the support frame 210.

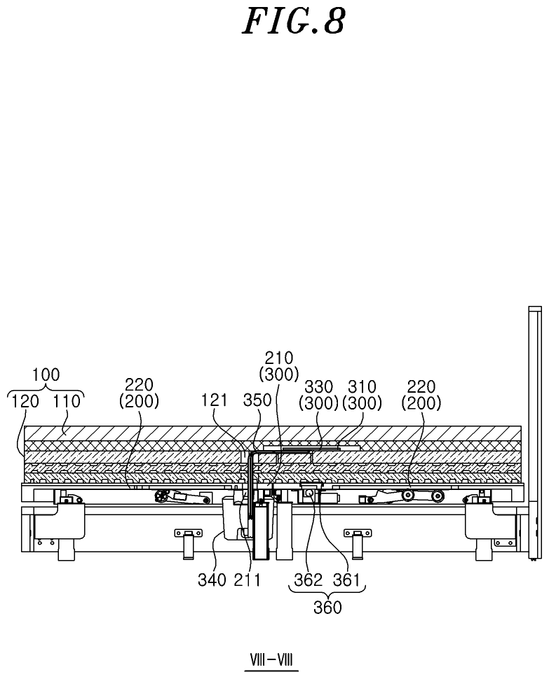

Referring further to FIG. 8, the air flow path 350 may provide a passage through which air flows. The air flow path 350 may be connected to the pump 340 and the air receiving part 310. The air flow path 350 may have one end connected to the pump 340, and the other end, which is opposite to the one end, connected to the air receiving part 310. The air flow path 350 may pass through the body hole 121 and the frame hole 211. The one end of the air flow path 350 may be positioned lower than the other end. In addition, a portion of the air flow path 350 located on the upper side of the body 120 may be inserted into the nipple groove 122.

The lifting part 360 can move up and down to raise or lower the mattress 100 to stretch the user's body. The lifting part 360 may be supported by the frame 200. In other words, the lifting part 360 is supported by the support frame 210 to move the lower surface of the body 120 up and down in the up-down direction, thereby raising or lowering the topper 110. The lifting part 360 may be disposed so that the air receiving part 310 overlaps the lifting part 360 in a region extending directly upward from the lifting part 360. By the lifting part 360, the portion of the body 120 that overlaps with the region directly above the support frame 210 can be moved up and down.

In addition, when the lifting part 360 is elevated, the air receiving part 310 can also be moved up and down along with the mattress 100. The lifting part 360 and the air receiving part 310 can stretch the same body part of the user, but the present disclosure is not limited thereto. In addition, the lifting distance of the lifting part 360 may be smaller than the height of the expanded air receiving part 310, but the present disclosure is not limited thereto. The lifting part 360 may include a lifting member 361 and a driving unit 362.

The lifting member 361 can be moved to raise or lower the mattress 100. The lifting member 361 may be supported on the support frame 210 to be movable up and down. A length of the lifting member 361 in the left-right direction may be greater than a length of the lifting member 361 in the front-back direction. For example, the lifting member 361 may be formed in a bar-like shape.

The driving unit 362 can provide driving force to the lifting member 361 to move the lifting member 361 up and down. In other words, when the driving unit 362 is driven, the lifting member 361 can move up and down. For example, the driving unit 362 may be a motor. In addition, the driving unit 362 may be configured to adjust the lifting distance of the lifting member 361. For example, the driving unit 362 may provide driving force to move the lifting member 361 by a first lifting distance or by a distance greater than the first lifting distance.

The valve may be opened and closed to allow or restrict the flow of air in the air flow path 350. In other words, the valve may be opened and closed to allow air to be introduced into or discharged from one or more of the lower cell 311 and the upper cell 312. A plurality of such valves may be provided. In addition, the valve may be opened and closed to allow air to be independently introduced into or discharged from the lower cell 311 and the upper cell 312. For example, when one of the lower cell 311 and the upper cell 312 is expanded through the operation of the valve, the other of the lower cell 311 and the upper cell 312 may or may not be expanded.

The controller 400 may control at least one of the pump 340 and the lifting part 360 to adjust the upward movement distance of the topper 110. In other words, the controller 400 may control the pump 340 to expand the air receiving part 310, or the driving member 362 to move the lifting member 361 up and down. The controller 400 may control the pump 340 so that at least one air receiving part 310 is expanded to raise the topper 110 by a first movement distance. The controller 400 may control the pump 340 and the lifting part 360 so that the lifting part 360 is moved up to raise the topper 110 by a second movement distance greater than the first movement distance while the at least one air receiving part 310 is expanded. In other words, the second movement distance of the topper 110 may be greater than the height of the expanded air receiving part 310 or the lifting distance of the lifting part 360.

In addition, the controller 400 may sequentially control the air receiving part 310 and the lifting part 360. In other words, the controller 400 may control the pump 340 and the lifting part 360 so that the topper 110 is raised by one of the one or more air receiving parts 310 and the lifting part 360, and then the topper 110 is further raised by the other of the one or more air receiving parts 310 and the lifting part 360.

Further, the controller 400 may control the valve so that at least some of the plurality of air receiving parts 310 are expanded differently. For example, the controller 400 may control the valve and the pump 340 to inflate only one of the lower cell 311 and the upper cell 312. In addition, the controller 400 may control the valve so that the plurality of air receiving parts 310 are expanded sequentially. In other words, the controller 400 may control the pump 340 and the valve so that the lower cell 311 and the upper cell 312 are expanded sequentially. By the controller 400, one of the lower cell 311 and the upper cell 312 can be inflated first, and then the other one of the lower cell 311 and the upper cell 312 can be inflated.

The controller 400 may control the pump 340 and the valve so that the topper 110 is raised by the lower cell 311 in the first step, and may control the pump 340 and the valve so that the topper 110 is raised by the upper cell 312 in the second step. In addition, the controller 400 may control the driving unit 362 so that the topper 110 is raised by the lifting member 361 in the third step. The controller 400 may control the driving unit 362, the pump 340 and the valve so that the topper 110 is raised by at least some of the lower cell 311, the upper cell 312 and the lifting member 361 in the fourth step. However, the control of the above first to fourth steps is exemplary, and therefore, the idea of the present disclosure is not limited thereto.

In addition, the controller 400 may control the rotation frame 420 to rotate relative to the support frame 410. The controller 400 may control the driving force of one or more motors specifically provided to rotate the rotation frame 420.

Hereinafter, the operations and effects of the bed 1 according to one embodiment of the present disclosure will be described.

According to one embodiment of the present disclosure, the controller 400 of the bed 1 can control the operation of the pump 340 and the lifting part 360 to adjust the upward movement distance of the topper 110, so that the intensity of stretching the user's body can be adjusted step by step.

In addition, since the air receiving part 310 and the lifting part 360 are arranged to overlap each other in the up-down direction, the moving distance of the topper 110 can be increased by the combined action of the air receiving part 310 and the lifting part 360, so that the stretching intensity experienced by the user can be maximized.

Further, the plurality of lower cells 311 can be arranged in the width direction of the bed 1 so that the user's body is positioned in a region extending directly upward between the plurality of lower cells 311, which allows the plurality of lower cells 311 to stably support the user's body when expanded.

Furthermore, the upper cell 312 and the lifting member 361 are formed in a bar-like shape so that the overlapping area with the user's body supported by the topper 110 can be reduced, which provides a stronger stimulus to the user.

In addition, the upward movement distance of the topper 110 can be greater than the height of the expanded air receiving part 310 or the lifting distance of the lifting part 360.

Further, since the rotation frame 220 can be rotated with respect to the support frame 210, the shape of the mattress 100 can be changed so that the user can be supported by the mattress 100 in a desired posture.

Although the embodiments of the present disclosure have been described as specific embodiments, these are merely examples, and the present disclosure should be interpreted to have the broadest scope according to the technical idea disclosed in the present specification without being limited thereto. Those skilled in the art may combine/substitute the disclosed embodiments to implement a pattern of a shape not specified, but this also falls within the scope of the present disclosure. In addition, those skilled in the art may easily change or modify the disclosed embodiments based on the present specification, and it is clear that such changes or modifications also fall within the scope of the present disclosure.

What is claimed is:

1. Abed comprising:
a mattress including a topper for supporting a user's body, and a body disposed below the topper to support the topper;
a frame supporting the mattress;
one or more air receiving parts supported by the body and configured to expand by receiving air or contract by discharging air to raise or lower the topper in an up-down direction to stretch the user's body;
a pump configured to operates to inflate or deflate the one or more air receiving parts;
a lifting part which is supported by the frame and moves up and down to raise and lower the mattress in the up-down direction to stretch the user's body; and
a controller for controlling the operation of at least one of the pump and the lifting part to adjust an upward movement distance of the topper.

2. The bed of claim 1, wherein the one or more air receiving parts are arranged to overlap with a region extending directly upward from the lifting part so that the one or more air receiving parts are moved upward together with the mattress when the lifting part moves upward.

3. The bed of claim 1, wherein the lifting part includes:
a lifting member supported by the frame to be movable up and down and configured to move the mattress up and down; and
a driving member for providing driving force to the lifting member.

4. The bed of claim 1, wherein the controller controls the operation of the pump so that the one or more air receiving parts are expanded to raise the topper by a first movement distance, and controls the operation of the pump and the lifting part so that the one or more air receiving parts are expanded and the lifting part is moved upward to raise the topper by a second movement distance greater than the first movement distance.

5. The bed of claim 1, wherein the controller controls the operation of the pump and the lifting part so that the topper is raised by one of the one or more air receiving parts and the lifting part, and then the topper is further raised by the other one of the one or more air receiving parts and the lifting part.

6. The bed of claim 1, further comprising:
an air flow path for allowing the pump and the one or more air receiving parts to communicate with each other; and
a valve configured to be opened and closed to allow or restrict flow of air in the air flow path;
wherein the one or more air receiving parts include:
a lower cell; and
an upper cell disposed on top of the lower cell, and
wherein the controller controls the operation of the pump and the valve so that the lower cell and the upper cell are sequentially expanded.

7. The bed of claim 6, wherein the upper cell and the lower cell are formed such that the height of the expanded upper cell and the height of the expanded lower cell are the same.

8. The bed of claim 1, wherein a lifting distance of the lifting part is smaller than a height of the one or more air receiving parts expanded.

9. The bed of claim 6, wherein the lower cell includes a plurality of lower cells, and the plurality of lower cells are arranged adjacent to each other in a width direction of the bed so that the user's body supported by the topper is positioned in a region extending directly upward between the plurality of lower cells.

10. The bed of claim 6, wherein the upper cell is formed in a bar-like shape extending in a width direction of the bed so that the user's body supported by the topper is positioned in a region extending directly upward from the upper cell.

11. The bed of claim 1, further comprising an air flow path connected to the pump and the one or more air receiving parts to provide a passage through which air flows,
wherein the frame has a frame hole,
the body has a body hole,
the frame hole and the body hole communicate with each other, and
the air flow path passes through the frame hole and the body hole and is connected to the one or more air receiving parts.

12. The bed of claim 1, wherein the lifting part moves a lower surface of the body up and down in the up-down direction to raise or lower the topper.

13. The bed of claim 1, wherein the frame includes:
a support frame supporting the lifting part and the one or more air receiving parts; and
one or more rotation frames arranged to be rotatable relative to the support frame.
